(19) United States
(12) Patent Application Publication
(10) Pub. No.: US 2006/0220286 A1
(43) Pub. Date: Oct. 5, 2006

(54) Hydraulic bushing with axial seal

(75) Inventors: Reimund Borgerding, Steinfeld (DE); Stefan Loheide, Wallenborst (DE); Thomas Mechelhoff, Dinklage (DE); Hubert Siemer, Dinklage (DE)

Correspondence Address: NORRIS, MCLAUGHLIN & MARCUS, 875 THIRD AVE, 18TH FLOOR, NEW YORK, NY, 10022, US

(73) Assignee: ZF Friedrichshafen AG, Friedrichshafen (DE)

(21) Appl. No.: 11/362,548

(22) Filed: Feb. 24, 2006

(30) Foreign Application Priority Data
Mar. 30, 2005 (DE) DE 102005014834.4

(51) Int. Cl. F16F 13/00

(52) U.S. Cl. 267/140.12

(57) ABSTRACT

A design of a bush bearing with hydraulic damping for achieving an axial seal for the chambers receiving the viscous damping means. The bearing is designed with an axial seal that reliably prevents the damping means from leaking out of the bearing as well as air from entering the bearing. In the bearing, the damping means chambers are sealed in a conventional manner by axial sealing lips, which are preferably formed by regions of the elastomer bearing body having an outer diameter that is greater than the inside diameter of the outer sleeve. One or several volumes are arranged in the region of the sealing lips, wherein the volumes extend at least along sections of the periphery of the bearing body and are not in fluid communication with the damping means chambers. The volumes are filled with a viscous fluid having a pressure that is essentially equal to or higher than the ambient pressure, but is always higher than the pressure in the damping means chambers.

### BACKRAOUND OF THE INVENITON

1. Field of the Invention

The invention relates to an axial seal for a bush bearing or a rubber bushing with hydraulic damping. The invention more particularly relates to the specific design of a corresponding bearing for implementing such axial seal for the chambers of the bearing that receive the viscous damping means.

2. Description of the Related Art

Different designs of elastomer bush bearings are frequently employed in the automotive industry, predominantly for chassis suspensions. Frequently, such bearings are not simply constructed of a rubber bushing with an inner part, an outer sleeve or an outer tube, and an elastomer bearing body arranged therebetween, but such bearings have a hydraulic element for aiding the damping action of the elastomer bearing body. The hydraulic section includes at least two chambers formed in the bearing body, which are filled with a viscous damping means and are connected by at least one channel for fluid communication. The bearing must be constructed so that the viscous damping means cannot leak from the axial ends of the bush bearing. Accordingly, the bearing is constructed to have seals on its axial ends.

For example, DE 196 16 638 C2 discloses a bearing with hydraulic damping, wherein the sealing function is implemented by a channel element which also forms the channel connecting the two damping means chambers. The channel element closes the chambers off at their respective end faces, i.e., at the axial ends of the bearing, in form of cap.

In one currently favored practical approach, the elastomer bearing body is oversized in the region of its axial ends in comparison to the tubular sleeve which receives the bearing. When the bearing is assembled and the outer sleeve is pushed on, a so-called calibration is performed which through application of suitable mechanical tools reduces the diameter of the outer sleeve, i.e., compresses the outer sleeve, at least in the region of the axial ends of the outer tube. This produces a pretension in the elastomer region formed on the axial ends of the bearing body, whereby the pretension causes the formation of a sealing lip or a sealing bead which provides a sealing function against the pressure difference between the bearing surroundings and the pressure in the interior of the bearing chambers. For example, DE 28 41 505 A1 discloses a bearing of this type.

The latter solution has proven effective to at least seal the bearing so that the viscous damping means cannot leak out. Stated differently, the solution disclosed in the aforementioned published document can reliably seal the bearing. Hydraulic bushings have been designed for specific applications where the pressure in the chambers of the bearing body which receive the viscous damping means is lower than the ambient pressure. However, there is a risk that although the damping means do not leak from the chambers, air may be able to enter the chambers. This can cause the interior pressure in the chambers to increase, which can adversely affect the operation of the components. This risk occurs because the viscosity of air is significantly lower than the viscosity of the damping means in the chambers. While the sealing action of the sealing lip formed on the bearing may be adequate for sealing the damping means, the sealing action may not be adequate to seal against intruding air. In particular, temperature changes can cause air to enter the chambers.

A similar problem is also addressed in EP 1 291 549 A1. This published document describes a hydraulic bushing with an axial seal which includes a cylindrical inner part, an elastomer bearing body surrounding the inner part, and an outer sleeve receiving the inner part with the bearing body, wherein at least two damping means chambers filled with a viscous damping means are arranged in the bearing body. The damping means chambers are connected with each other by a flow channel or throttle channel. The damping means chambers are sealed by axial sealing lips which prevent the damping means from leaking out. At least one volume is formed in the region of the sealing lips which extends at least along sections of the periphery of the bearing body and is arranged separate from the damping means chambers and the connecting channel. The volume is filled with a viscous fluid.

A hydraulic bushing of this type must therefore use the same fluid in the volumes between the sealing lips as in the damping means chambers. With this conventional embodiment, once air has entered the sealed region, the air can disadvantageously also enter the damping means chambers through the recesses disposed on the inner axial sealing lip. However, this risk must be eliminated because the hydraulic bushing would otherwise cease to function.

JP 07269639 A also discloses a hydraulic bushing with an axial seal which includes an inner part, an elastomer bearing body surrounding the inner part and connected thereto by vulcanization, and an outer sleeve receiving the inner part together with the bearing body. The bearing body has axial sealing lips, whereby volumes are formed at least along sections of the periphery of the bearing body. These volumes receive a viscous fluid which has a pressure that is essentially equal to or higher than the ambient pressure.

In addition, WO 02/16800 A1 is directed to a hydraulic bushing with an axial seal, which includes an essentially cylindrical inner part, an elastomer bearing body surrounding the inner part and connected thereto by vulcanization, and an outer sleeve receiving the inner part together with the bearing body. This hydraulic bushing also includes at least two damping means chambers in the bearing body, which are filled with a viscous damping means and connected by a flow channel or throttle channel. The damping means chamber are sealed by axial sealing lips to prevent the damping means from leaking out. One or several volumes are arranged in the region of the sealing lips, with the volumes extending at least along sections of the periphery of the bearing body and arranged separate from the damping means chambers and the connecting channel. These volumes are filled with a viscous fluid, whereby the volumes arranged in the region of the sealing lips are not connected with the damping means chambers for fluid communication and are filled with a viscous fluid. The pressure in these volumes is essentially equal to or higher than the ambient pressure, but is always higher than the pressure in the damping means chambers.

### SUMMARY OF THE INVENTION

It is an object of the invention to design an elastomer hydraulic bush bearing with an axial seal providing a sealing action that prevents not only the damping means from leaking from the bearing, but also prevents air from entering the bearing.

The object is solved by a hydraulic bushing and an elastomer bush bearing, respectively, having the characteristic features of the independent claim. Advantageous embodiments and/or improvements of the inventive bearing are recited in the dependent claims.

The proposed hydraulic bearing is a bush bearing of a generally known design. The bearing includes an essentially cylindrical, preferably hollow-cylindrical inner part, an elastomer bearing body surrounding the inner part and connected thereto by vulcanization, as well as an outer sleeve receiving the afore-mentioned components, i.e., the inner part with the bearing body. Hydraulic damping is implemented by arranging at least two damping means chambers in the elastomer bearing body which are filled with a viscous damping means and are connected to one another by a throttle channel or flow channel. The damping means chambers are sealed against leakage of the damping means by axial sealing lips. These sealing lips are preferably implemented by regions of the elastomer bearing body, which have an outer diameter which is greater than the inside diameter of the outer sleeve. A pretension is generated in the elastomer in the oversized regions during assembly or when the outer sleeve is pushed onto the bearing body, which produces a reliable seal against leakage of the high-viscosity damping means. However, as mentioned above, the sealing action of the sealing lips implemented in this manner may not be adequate to prevent air from entering, since the viscosity of air is significantly lower than the viscosity of the damping means. In particular, air may be able to enter when the pressure in the damping means chambers is lower than the ambient pressure, as may be desirable in certain applications. Ambient air at a higher pressure may then be able to enter the damping means chambers in spite of the presence of the sealing lip, which can impair the operation of the bearing or make the bearing unusable. The arrangement of the invention provides a significantly improved sealing action in particular in bearings of the latter type, i.e., hydraulic bearings having a reduced pressure in the damping means chambers. For this purpose, one or more volumes are formed in the bearing body in the region of the sealing lips. The volumes extend at least along sections of the periphery of the bearing body and are filled with a viscous fluid. The pressure of the viscous fluid is essentially equal to or higher than the ambient pressure, but is always higher than the pressure of the damping means in the damping means chambers. The aforementioned volumes are formed separate from the damping means chambers and the channel connecting the damping means chambers, i.e., they are not in fluid communication with the damping means chambers. According to the invention, the volumes and the viscous fluid disposed in the volumes form additional viscous seals for the bearing.

The terminology used above and in the independent claim, namely that the pressure in the viscous seals is essentially equal to or greater than the ambient pressure, is meant to indicate that the latter is preferred, but that a sealing action may potentially also be achieved if the pressure of the fluid in the viscous seals is lower than the ambient pressure. Only a small quantity of ambient air may then be able to enter the viscous seals, without being able to reach the damping means chambers.

According to an advantageous embodiment, the fluid used in the viscous seals may have a viscosity that is different from the viscosity of the damping means or may have a similarly high viscosity.

According to another advantageous embodiment, the bearing may be produced with a pressure in the volumes of the viscous seals than is slightly higher than the ambient pressure. However, under extreme ambient conditions, i.e., under extreme ambient pressure conditions, this pressure may temporarily be smaller than the actual ambient pressure. Within the context of the invention, the pressure in the viscous seals is then still essentially at least equal to the ambient pressure, i.e., the pressure is approximately equal to or possibly (even if only for short time) lower than the ambient pressure.

To achieve a reliable sealing action with the viscous seals, the inventive bearing is preferably constructed so that the pressure of the fluid in the viscous seals is higher than the ambient pressure. The pressure is applied during manufacture of the bearing, during its calibration, by the walls that form the boundaries of these volumes or of the additional chambers, and is preferably set to be always greater than the highest realistic ambient pressure. The pressure increase in the viscous seals following calibration is due to the incompressibility of the fluid in the corresponding volumes. It should be mentioned that even for bearings where the pressure in the damping means chambers is not less than the ambient pressure, the viscous seals according to the invention provide an improved sealing action by preventing air from entering the bearing, in particularly when the pressure of the fluid in the viscous seals is higher than ambient pressure.

So as not to significantly increase the manufacturing cost of the bearing in spite of the additional viscous seals, the bearing is preferably constructed to use the same viscous fluid in the viscous seals as for damping the bearing in the damping means chambers. This is advantageous since the bearings are generally assembled immersed in a fluid, i.e., in the same fluid that later forms the damping means, so that the damping means chambers and the volumes for the viscous seals can be filled in a single operation. Using suitable tools, the elastomer can be pushed or pulled radially outwardly in the region of the damping means chambers during assembly, which produces a reduced pressure in the damping means chambers after the outer sleeve is pushed over the other components and the force causing the corresponding deformation of the elastomer is removed. At the same time, the volumes for the viscous seals filled with the viscous fluid can be closed off with the outer sleeve alone, without a preceding deformation. The pressure in the fluid can then be increased by the subsequent calibration in the corresponding regions, i.e., by an intentional decrease of their diameter.

According to an advantageous embodiment, ethylene glycol can be used in practical applications as a viscous fluid, both for achieving the damping action and for filling to the viscous seals. Viscous seals with different geometries, for example, of the volumes receiving of the viscous fluid can be designed, depending on the specific application. Viscous seals can be formed, for example, by continuous grooved channels that extend around the entire periphery at the axial ends of the bearing. Alternatively, a groove can be discontinuous at locations that do not require a sealing action, for example, in the region of the support channel. In this case, the viscous seals are formed in segments.

### BRIEF DESCRIPTION OF THE DRAWINGS

The invention will be described hereinafter with reference to an exemplary embodiment. In the corresponding drawings,

FIG. 1 shows in an axial cross-sectional view one axial half of an embodiment of the bearing of the invention; and

FIG. 2 shows for comparison the corresponding segment of a conventional bush bearing.

### DETAILED DESCRIPTION OF THE PRESENTLY PREFERRED EMBODIMENTS

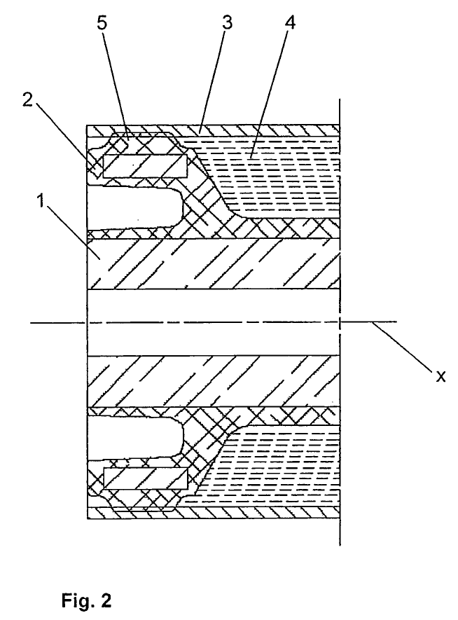

The invention will be described first with reference to FIG. 2, which shows in an axial cross-section one axial half of a conventional hydraulic bushing. The bearing includes essentially a generally metallic inner part 1, an elastomer bearing body 2 connected with the inner part 1 by vulcanization, and a tubular bearing sleeve or outer sleeve 3 receiving the inner part 1 together with the bearing body 2. Two damping means chambers 4, 4′ filled with a viscous damping means are formed in the bearing body 2, whereby the damping means chambers 4, 4′ are connected with one another via an overflow channel or throttle channel (not shown in FIG. 2). As mentioned above, FIG. 2 only shows one axial half of the body which is essentially rotationally symmetric with respect to the x-axis.

The rubber spring forming the bearing body 2 has in a region of the axial bearing end a section with an enlarged outer diameter. The outer diameter of the bearing body 2 is here oversized with respect to the inside diameter of the outer sleeve 3. When the outer tube 3 is pushed over the bearing body 2 and calibrated, i.e., the diameter of the outer sleeve 3 is reduced, a pretension is produced in the sections of the bearing body 2 having an increased diameter, in particular at the axial ends of the bearing body 2, so that these regions operate as a sealing lip 5 or a sealing bead. The bearing is hereby reliably sealed, preventing the viscous fluid disposed in the damping means chambers 4, 4′ from leaking out. As mentioned above, the viscosity of air is significantly smaller than the viscosity of the damping means in the damping means chambers 4, 4′, so that if the pressure of the damping means chambers 4, 4′ is less than the ambient pressure, as may be desirable in certain applications, there is still a risk with this type of seal 5 that air can enter the damping means chambers 4, 4′.

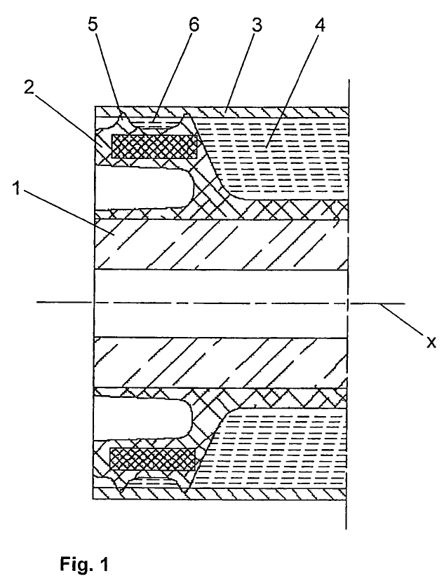

The problem is solved by designing the bearing according to the invention. A corresponding embodiment of the inventive bearing is shown in FIG. 1, which shows a detail similar to that of FIG. 2, i.e., only one axial half of the bearing. The design of this design bearing is essentially identical to the design of the bearing depicted in FIG. 2, including an inner part 1, a bearing body 2 that is vulcanized on the inner part 1, and a tubular outer sleeve 3 receiving the two aforementioned components. Damping means chambers 4, 4′ for receiving viscous damping means are similarly arranged in the bearing body 2. The damping means chambers 4, 4′ are, as with conventional bearings, sealed on the depicted axial end by a corresponding sealing bead 5 which prevents the damping means from leaking out. However, according to the invention, an additional volume 6 which is also filled with the damping means and is not in fluid communication with the damping means chambers 4, 4′ is arranged in the region of the sealing lip 5. The volume 6 is implemented either as a continuous circumferential channel, which should not to be confused with the throttle channel, or as a grooved channel, or as chambers formed along sections of the periphery of the sealing lip 5. The volume 6 is also filled with the damping means and has typically, but not necessarily, a smaller volume than the damping means chambers 4, 4′ which produce the damping action of the bearing. Regardless if the actual damping means chambers 4, 4′ have a reduced pressure or not, a quantity of the viscous fluid is introduced into the additional volume 6, and an overpressure with respect to the ambient pressure is generated by the outer walls, due to the incompressibility of the viscous fluid, when the outer sleeve is pushed over the other components and the outer sleeve 3 is thereafter calibrated (i.e., its diameter is reduced). Because, as already mentioned, the sealing action of the sealing lips 5 is adequate for the viscous damping means, the damping means are unable to leak out from the additional volume 6 either to the outside or into the damping means chambers 4, 4′. The pressure in the additional volume 6 reliably prevents ambient air from entering the bearing and the damping means chambers 4, 4′ of the bearing which may be at a reduced pressure.

What is claimed is:

1. A hydraulic bushing with an axial seal, comprising
an substantially cylindrical inner part,
an elastomer bearing body surrounding the inner part and connected thereto by vulcanization, and
an outer sleeve receiving the inner part with the bearing body,
wherein at least two damping means chambers are arranged in the bearing body, which are filled with a viscous damping means and are connected with each other by a flow channel or throttle channel, wherein the damping means chambers are sealed by sealing lips to prevent the damping means from leaking out, wherein one or several volumes are arranged in the region of the sealing lips, with the volumes extending at least along sections of the periphery of the bearing body and being separate from the damping means chambers and from the channel connecting the damping means chambers and being filled with a viscous fluid, wherein the volumes arranged in the region of the sealing lips are not connected for fluid communication with the damping means chambers and are filled with a viscous fluid having a pressure that is essentially equal to or higher than the ambient pressure, but is always higher than the pressure in the damping means chambers, and
wherein the fluid in the volumes has a viscosity that is a different from the viscosity of the damping means or has a similarly high viscosity.

2. The hydraulic bushing according to claim 1, wherein the viscous seals formed by the volumes filled with the viscous fluid have an overpressure relative to the ambient pressure.

3. The hydraulic bushing according to claim 1, wherein the viscous fluid in the viscous seals is the same fluid that is used also as a damping means.

4. The hydraulic bushing according to claim 3, wherein the viscous fluid of the viscous seals and of the damping means is ethylene glycol.

5. The hydraulic bushing according to claim 1, wherein the viscous seals (6) are formed as grooved channels which extend continuously around the periphery of the bearing body.

6. The hydraulic bushing according to claim 1, wherein at least one suitably formed viscous seal is arranged on each of the axial bearing ends.
